(19) United States
(12) Patent Application Publication
(10) Pub. No.: US 2025/0305462 A1
(43) Pub. Date: Oct. 2, 2025

(54) GASEOUS AND DUAL FUEL INTAKE SYSTEM FOR DIESEL AND GASOLINE ENGINES

(71) Applicant: Dynamic Fuel Systems, Inc., Winter Park, FL (US)

(72) Inventor: Jeffrey R. Bach, Sanford, FL (US)

(21) Appl. No.: 19/098,699

(22) Filed: Apr. 2, 2025

Related U.S. Application Data
(60) Provisional application No. 63/573,337, filed on Apr. 2, 2024.
(60) Provisional application No. 63/682,253, filed on Aug. 12, 2024.

(51) Int. Cl. F02D 19/06; F02D 19/12

(52) U.S. Cl. CPC F02D 19/0642; F02D 19/0671; F02D 19/12; F02D 19/0665

(57) ABSTRACT

The invention involves a system and method for providing a liquid fuel or a liquid and gaseous fuel to a diesel cycle or Otto cycle engine for operation of the engine. The system includes a primary electronic control module (ECM) which monitors engine sensors and contains least one three-dimensional (3D) fuel map for the liquid fuel and one for gaseous fuel. A gaseous fuel injection assembly is provided for the injection of the gaseous fuel to the engine. The gaseous fuel is transported on the vehicle in a liquid form and converted to a gaseous fuel via a fuel phase converter utilizing the air being drawn into the engine by the combustion process. The liquid fuel is warmed while the incoming air is cooled to increase air density of the air being drawn into the engine, thereby increasing engine performance and lowering the emissions output of the engine.

### RELATED APPLICATIONS

In accordance with 37 C.F.R. 1.76, a claim of priority is included in an Application Data Sheet filed concurrently herewith. Accordingly, the present invention claims priority to U.S. Provisional Application No. 63/682,253, entitled “GASEOUS AND DUAL FUEL INTAKE SYSTEM FOR DIESEL AND GASOLINE ENGINES”, filed Aug. 12, 2024, and to U.S. Provisional Application No. 63/573,337, entitled “GASEOUS AND DUAL FUEL INTAKE SYSTEM FOR DIESEL AND GASOLINE ENGINES”, filed Apr. 2, 2024. The present Application is also related to U.S. patent application Ser. No. 18/045,381, entitled “DUAL FUEL INJECTION SYSTEM FOR OPTIMIZING FUEL USAGE AND MINIMIZING SLIP FOR DIESEL AND GASOLINE ENGINES”, filed Oct. 10, 2022, now U.S. Pat. No. 12,018,610, which issued Jun. 25, 2024, which claimed priority as a continuation of U.S. patent application Ser. No. 17/588,162, entitled “DUAL FUEL INJECTION SYSTEM FOR OPTIMIZING FUEL USAGE AND MINIMIZING SLIP FOR DIESEL AND GASOLINE ENGINES”, filed Jan. 28, 2022, now U.S. Pat. No. 11,486,295, which issued on Nov. 1, 2022, and claimed priority as a continuation of U.S. patent application Ser. No. 17/110,781, entitled “DUAL FUEL INJECTION SYSTEM FOR OPTIMIZING FUEL USAGE AND MINIMIZING SLIP FOR DIESEL ENGINES”, filed Dec. 3, 2020, now U.S. Pat. No. 11,236,665, which issued on Feb. 1, 2022, and claimed priority as a continuation of U.S. patent application Ser. No. 16/240,385, entitled “DUAL FUEL INJECTION SYSTEM FOR OPTIMIZING FUEL USAGE AND MINIMIZING SLIP FOR DIESEL ENGINES”, filed Jan. 4, 2019, now U.S. Pat. No. 10,890,106, which issued on Jan. 12, 2021, and claimed priority to U.S. Provisional Patent Application No. 62/613,552, entitled “DUAL FUEL INJECTION SYSTEM FOR OPTIMIZING FUEL USAGE AND MINIMIZING SLIP FOR DIESEL ENGINES”, filed Jan. 4, 2018.

### FIELD OF INVENTION

The present invention generally relates to internal combustion engines, and more particularly, to an intake air cooling system that utilizes fuel phase change to provide cooling for dual fuel diesel and Otto cycle engines.

### BACKGROUND INFORMATION

For more than a century, internal combustion engines have been relied upon as a principal source of power in a variety of applications. Of those engines, the most widely used are the reciprocating piston diesel engines which are found in automobiles, trucks, trains and earth moving equipment, as well as other forms of transportation and a variety of industrial and consumer applications. Such engines can be built in a variety of sizes, types, and configurations depending on the power requirements of a particular application. The diesel cycle is a combustion process of a reciprocating internal combustion engine. In it, fuel is injected as a liquid into the cylinder and ignited by heat generated by the compression of air in the combustion chamber. In a direct injection engine, the fuel is directly injected into the compressed, and thus heated, air within the cylinder. The Otto cycle engine describes the functioning of a typical spark ignition piston engine. Spark ignition engines either pull in air containing atomized fuel to the cylinder for compression, or fuel is directly injected into compressed air contained within the cylinder for combustion.

In an effort to increase the efficiency and reduce the emissions of the diesel cycle engine, various liquid fuels, as well as multi-fuels, have been utilized. A multi-fuel engine refers generically to any type of engine which is designed to burn multiple types of fuels in a single cycle for its operation. Multi-fuel engines have application in diverse areas to meet particular operational needs in the operating environment. Multi-fuel engines are also desirable where cheaper fuel sources, such as natural gas or propane, are available and are combusted in combination with diesel fuel.

A multi-fuel engine typically operates with a specified mixture of the available fuels. Where a liquid-only fuel mixture is specified, a liquid fuel, such as diesel fuel, gasoline, dimethyl ether (DME), or other liquid and/or hydrocarbon fuel, is injected directly into an engine cylinder or a pre-combustion chamber as the sole source of energy during combustion. When a liquid and gaseous fuel mixture is specified, a gaseous fuel, such as natural gas, methane, hexane, pentane, DME or any other appropriate gaseous hydrocarbon fuel, may be mixed with air in an intake port of a cylinder and a small amount or pilot amount of liquid fuel, such as diesel fuel having a cetane value, is injected into the cylinder or the pre-combustion chamber in order to ignite the mixture of air and gaseous fuel.

Internal combustion engines generate exhaust as a by-product of fuel combustion within the engines. Engine exhaust contains, among other things, un-burnt fuel, particulate matter such as soot, and harmful gases such as carbon monoxide or nitrous oxide. To comply with regulatory emissions control requirements, it is desirable to reduce the amount of soot and harmful gasses generated by the engine. Due to the rising cost of liquid fuel (e.g. diesel fuel) and to comply with the emissions control requirements, engine manufacturers have developed dual-fuel engines. Using a lower-cost fuel together with liquid fuel helps improve the cost efficiency of the engine. Further, combustion of the gaseous fuel and liquid fuel mixture, if completed properly, lowers the production of undesirable emissions from the engine.

Examples of the utilization of alternative fuels for the diesel cycle engine are as old as the diesel engine itself. The inventor of the diesel engine, Rudolph Diesel—1897, used “natural gas” as a diesel engine fumigant fuel charge. Fumigation of a diesel engine is the addition of a gaseous fuel to the intake air charge of a diesel engine. Development of diesel engine fumigation techniques has continued, such as those disclosed in Ritter et al., U.S. Pat. No. 6,901, 889 and Bach, U.S. Pat. No. 7,100,582.

The pre-heating of diesel fuel to improve combustion efficiency and reduce exhaust gas pollutants has been known since the 1930's. Hypergolic diesel combustion received significant attention in the 1980's. More recently, Tavlarides et al., U.S. Pat. No. 7,488,357 and others disclose methods and apparatus which cause diesel fuel to become supercritical prior to injection into the combustion chamber.

U.S. Pat. No. 4,892,561 to Levine discloses fuels for internal combustion engines which contain at least 50% by weight of methyl ether.

U.S. Pat. No. 5,632,786 to Basu et al. describes a method for operating a spark ignition internal combustion engine utilizing an improved composition containing dimethyl ether and propane as fuel.

U.S. Pat. No. 6,095,102 to Willi et al. teaches a dual fuel engine which creates a substantially homogeneous mixture of gaseous fuel, air, and pilot fuel during a compression stroke.

U.S. Pat. No. 6,145,495 to Whitcome discloses a propane injection system for a diesel engine.

U.S. Pat. No. 6,202,601 to Ouellette et al. describes a method and apparatus for dual fuel injection into an internal combustion engine. A main fuel is ignited by a pilot fuel that is more readily flammable than the main fuel.

U.S. Pat. No. 6,206,940 to Weissman et al. teaches fuel formulations to extend the lean limit.

U.S. Pat. No. 6,213,104 to Ishikiriyama et al. discloses supplying fuel to an internal combustion engine in a supercritical state by raising the pressure and the temperature of the fuel above the critical pressure and temperature.

U.S. Pat. No. 6,286,482 to Flynn et al. describes a premixed charge compression ignition engine with combustion control.

U.S. Pat. No. 6, 324, 827 to Basu et al. teaches a method of generating power in a dry low NOx combustion system.

U.S. Pat. No. 6,607,567 to Towfighi discloses propellant gas for tools operated by combustion power on the basis of combustible gases containing a mixture of 40% to 70% by weight of dimethyl ether, nitrous oxide and/or nitromethane, 8% to 20% by weight of propylene, methyl acetylene, propane and/or propadiene and 20% to 45% by weight of isobutane and/or n-butane.

U.S. Pat. Nos. 6,901,889 and 7,225,763 to Ritter et al. describe systems and methods to reduce particulate and NOx emissions from diesel engines through the use of a dual fuel fumigation system.

U.S. Pat. No. 7,488,357 to Tavlarides et al. teaches a composition of diesel, biodiesel or blended fuel with exhaust gas mixtures or with liquid CO2. The composition is in a liquid state near the supercritical region or a supercritical fluid mixture such that it quasi-instantaneously diffuses into the compressed and hot air as a single and homogeneous supercritical phase upon injection into a combustion chamber.

Downsides to dual fuel engines are also well known; the gaseous fuel is typically introduced into the intake runner or combustion chambers of the engine during an intake stroke. Because exhaust valves of the combustion chambers may remain open for a portion of the intake stroke, some of the gaseous fuel can escape or “slip” out through the open exhaust valves. The fuel that escapes from the combustion chambers does not participate in combustion, reducing the efficiency of the engine. Additionally, the escaping unburned gaseous fuel contributes to the total amount of undesirable emissions produced by the engine.

One technique for reducing gaseous fuel slip from the combustion chambers is disclosed in International Publication No. WO 2013/068640 to Hägglund (“the '640 publication”) that published on May 16, 2013. The '640 publication discloses various embodiments to remove and treat unburned gaseous fuel trapped in dead volumes in the combustion chamber where no combustion occurs. The '640 publication discloses an arrangement of conduits that remove a portion of the exhaust containing the unburned gaseous fuel separately from the remaining portion of the exhaust. The '640 publication also discloses a processing unit for treating the portion of the exhaust containing the unburned gaseous fuel. The treated exhaust is then allowed to mix with the remainder of the exhaust.

Although the '640 publication discloses the use of a processing unit to treat unburned gaseous fuel for improving engine emissions, the disclosed apparatus and method may still not be optimal. In particular, the disclosed apparatus of the '640 publication removes the unburned gaseous fuel after completion of combustion in the engine cylinders. Thus, the unburned gaseous fuel does not contribute to generation of power in the engine, reducing the efficiency of the engine. Further, the disclosed apparatus of the '640 publication requires the use of additional ducting and the use of a processing unit, which may increase the cost of manufacturing and operating the engine. Thus, there is a need in the art for further development of dual fuel diesel cycle engines.

Most modern diesel engines utilize computer control for the introduction of fuel to the combustion chamber. A typical engine speed controller has one controller that acts on speed error to set a fuel rate. For engines that may run on multiple fuels, it is required to set multiple fuel rates based on the fuel fraction or desired ratio of fuels. For example, it may be desired to run a multi-fuel engine on a mixture of 80% natural gas and 20% diesel. However, typical speed controllers (usually proportional-integral controllers, commonly called PI controllers) may only set a fuel rate for a single fuel. The normal way to deal with a multi-fuel engine is to have each PI controller set an individual fuel rate for the corresponding fuel while ignoring the fact that there are other fuels supplying power to the engine. The fuel rates are set as if the other fuels do not exist. After the individual fuel rates are set by the PI controllers, a complicated switching strategy manages the multiple fuel rates, and selects a composite fuel flow based on the specified fuel mixture. The selected composite fuel flow accounts for the availability of the other fuels. If a specific fraction of fuel is desired, such as the 80% natural gas, 20% diesel fuel mixture discussed above, the switching strategy will output multiple fuel flow rates. In this case, separate control signals will be output to the flow control devices for natural gas and diesel fuel to create the fuel flows of each fuel that are necessary for the composite fuel flow. The disadvantages of this type of control structure include the significant amount of design time and effort required for multiple PI controllers and the complexity of the switching strategy to ensure that the overall design is robust and responsive to changes in the input power requirements.

The fuel properties for the fuel may have to be manually input each time an engine tank has to be refilled. The quality of the fuel being used in the engine and the fuel tested in the lab may be different. Also, the quality of the fuel may change after operating the engine for a predetermined time duration. Under such circumstances, the fuel flow rate determined based on the input fuel properties may not be accurate. In view of these conditions, a need exists for an improved multi-fuel engine control strategy that simplifies the process for determining the fuel flow rates for the various fuels available to provide power to the engine. While the multi-fuel engine control strategy disclosed in U.S. Pat. Nos. 10,890,106, 11,236,665 and U.S. Publication No. 2023/0175430-A1 is suitable for mixing fuels of various quality utilizing a learning computer that includes two fuel maps, there exists a need in further reducing emissions and improving the efficiency of gaseous and dual fuel engines.

The intake system of the present disclosure solves one or more of the problems set forth above and/or other problems in the art by providing a system that can be retrofit to pre-existing engines as well as new engine systems. The system is suitable for reducing intake air temperatures to reduce emissions, such as NOX gas, while improving air density and horsepower ratings which allow for lower throttle positions, while achieving the same horsepower and torque. The system utilizes at least one alternative fuel that requires pressure to remain a liquid at room temperatures and may also utilize diesel in a dual fuel arrangement.

### SUMMARY OF THE INVENTION

Briefly, the invention involves a system and method for providing a liquid fuel or a liquid and gaseous fuel to a diesel cycle or Otto cycle engine for operation of the engine. The system includes a primary electronic control module (ECM) which monitors engine sensors and contains at least one three-dimensional (3D) fuel map for the liquid fuel and one fuel map for gaseous fuel, both fuel maps may also be incorporated into one 3D fuel map. In some embodiments the ECM may include an artificial intelligence or (AI) control circuit for predicting fuel requirements and for controlling two different fuels in a dual fuel engine. A gaseous fuel injection assembly is provided for the injection of the gaseous fuel to the engine. The engine may also include a diesel injection system. The alternative gaseous fuel is transported on the vehicle in a liquid form under pressure at ambient temperatures. The pressurized storage allows the storage of fuels that would normally vaporize at atmospheric pressure and temperatures of 0 degrees Celsius or lower. A fuel phase converter is provided to convert the pressurized liquid fuel from its liquid phase to a gaseous phase utilizing the air being drawn into the engine by the combustion process. The liquid fuel is changed in phase and expanded by addition of heat or forcing the liquid through a metering/expansion orifice and reducing the pressure to cause cooling like a refrigeration circuit. The incoming air is cooled by the phase changed fuel to increase air density of the air being drawn into the engine, thereby increasing engine performance and lowering the emissions output of the engine by at least reducing combustion temperatures. In some additional embodiments, a refrigeration compressor is provided as part of the system to recompress and thus allow the re-expansion of the same fuel multiple times as a portion of the expanded fuel is consumed by the engine.

Accordingly, it is an objective of the present invention to provide an air intake system for converting the phase of a pressurized liquid fuel into a gaseous phase fuel for fueling an internal combustion engine.

It is another objective of the present invention to provide an intake system for an internal combustion engine that converts a pressurized liquid fuel into a gaseous fuel and provides the gaseous fuel to an Otto cycle engine.

It is a further objective of the present invention to provide an intake system for an internal combustion engine that utilizes intake air flow to supply heat to a pressurized liquid fuel to convert the liquid into a gaseous fuel for consumption by the engine.

It is yet a further objective of the present invention to provide an intake system for an internal combustion engine that converts a pressurized liquid fuel to a gaseous fuel while cooling the intake air flowing to the engine.

It is another objective of the present invention to provide an intake system for an internal combustion engine that converts a pressurized liquid fuel to a gaseous fuel using intake air where the intake air does not directly contact the fuel while converting its phase.

It is still yet another objective of the present invention to provide an intake system for an internal combustion engine that includes a compressor and a metering/expansion valve whereby the alternative fuel can be compressed and re-expanded for cooling the incoming intake air.

It is yet another objective of the present invention to provide a refrigeration cycle for the phase converting fuel that can be reversed to provide heat to the intake air of the engine for cold running conditions.

It is still another objective of the present invention to provide an intake system for an internal combustion engine that cools incoming intake air to below zero degrees Celsius before the air enters the engine.

Still yet another objective of the present invention is to provide an intake system for an internal combustion engine that collects condensation from the incoming air stream and for reinjection as hydrogen and oxygen as determined by an ECU.

A even further objective of the present invention is to provide an intake system for an internal combustion engine that utilizes artificial intelligence to control a “learned anticipative fuel strategy” which uses learned fuel curves stored in the ECU to anticipate the diesel fuel demand and the alternative fuel demand to apply actions prior to the actual occurrence of the fuel demand.

A still further objective of the present invention is to provide an intake system for an internal combustion engine that utilizes parameters such as diesel fuel consumption, engine load, engine RPM, engine temperature, exhaust temperature, air intake temperature, ambient temperature, emissions sensors to make artificial intelligence decisions regarding how much alternative fuel to supply to the engine for combustion and, in some embodiments, the addition and dual fuel operation of a diesel engine.

Other objectives and advantages of this invention will become apparent from the following description taken in conjunction with the accompanying drawings wherein are set forth, by way of illustration and example, certain embodiments of this invention. The drawings constitute a part of this specification, include exemplary embodiments of the present invention, and illustrate various objects and features thereof.

### BRIEF DESCRIPTION OF THE FIGURES

FIG. 1 is a side view partially in section representing one embodiment of the present invention;

FIG. 2 is a partial exploded view, illustrating the components of the fuel phase converter of the present invention;

FIG. 3 is a partial side view taken along a longitudinal centerline of the fuel phase converter, illustrating the air flow path through the device;

FIG. 4 is a front perspective view, illustrating an air inlet cone of the fuel phase converter;

FIG. 5 is a rear perspective view, illustrating a rear view of the air inlet cone;

FIG. 6 is a rear perspective view, illustrating a rear view of the air inlet cone;

FIG. 7 is a front, top perspective view, illustrating a front view of the air inlet cone;

FIG. 8 is a top, front perspective view, illustrating a cooling cartridge of the present device;

FIG. 9 is a front, right perspective view of a first cooling cartridge assembly;

FIG. 10 is a front, right perspective view of a second cooling cartridge assembly;

FIG. 11 is a top, front right perspective view of a cooling cartridge sleeve;

FIG. 12 is an end view of the cooling cartridge end cap;

FIG. 13 is an enlarged perspective view of a cooling cartridge end cap;

FIG. 14 is a perspective view, illustrating a centrifugal inertia swirler and fuel collection ring;

FIG. 15 is a perspective view, illustrating the centrifugal inertia swirler and fuel collection ring;

FIG. 16 is a top, rear perspective view illustrating the fuel collection shroud;

FIG. 17 is a section view taken along lines 17-17 of FIG. 16 illustrating the fuel collection conduit;

FIG. 18 is a top, rear perspective view of the water collection shroud;

FIG. 19 is a top, rear perspective view of the water collection shroud;

FIG. 20 is a section view of the water collection shroud taken along lines 20-20 of FIG. 19;

FIG. 21 is a section view of the water collection shroud taken along lines 20-20 of FIG. 19;

FIG. 22 is a front perspective view of the water collection shroud;

FIG. 23 is a front perspective view of the water collection shroud;

FIG. 24 is a schematic of the compressor cycle of the present system; and

FIG. 25 is a schematic of a reversable refrigeration cycle for use with converting fuel phases and heating/cooling intake air.

### DETAILED DESCRIPTION OF THE PREFERRED EMBODIMENTS

While the present invention is susceptible of embodiment in various forms, there is shown in the drawings and will hereinafter be described a presently preferred embodiment with the understanding that the present disclosure is to be considered an exemplification of the invention, and is not intended to limit the invention to the specific embodiments illustrated.

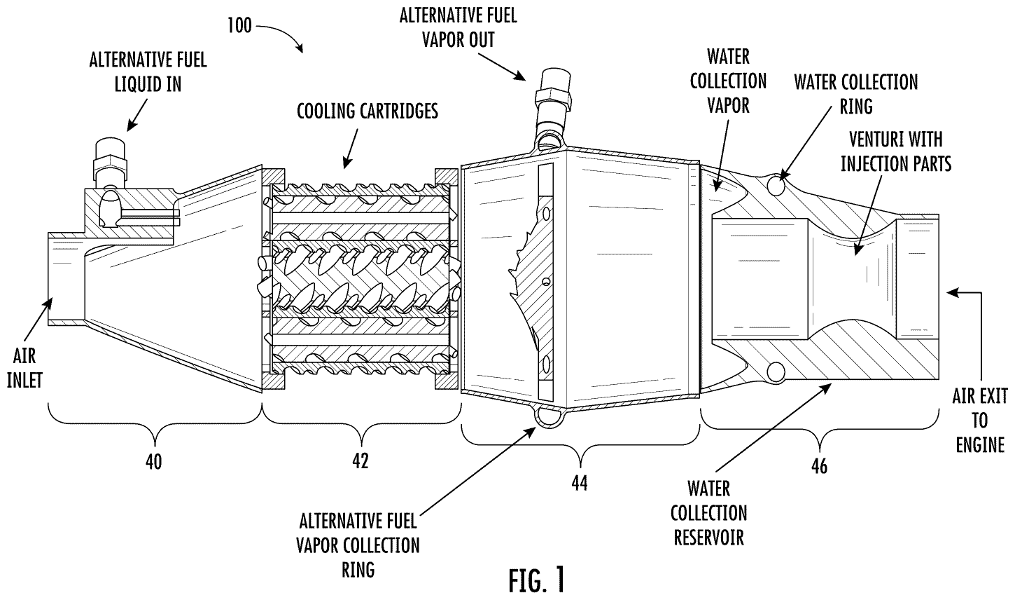

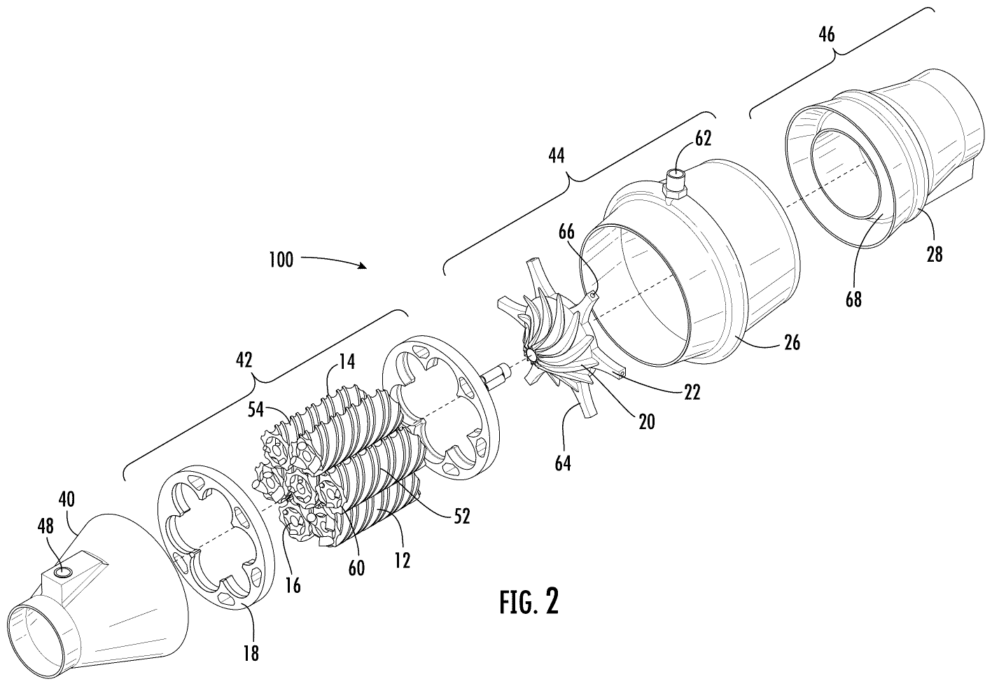

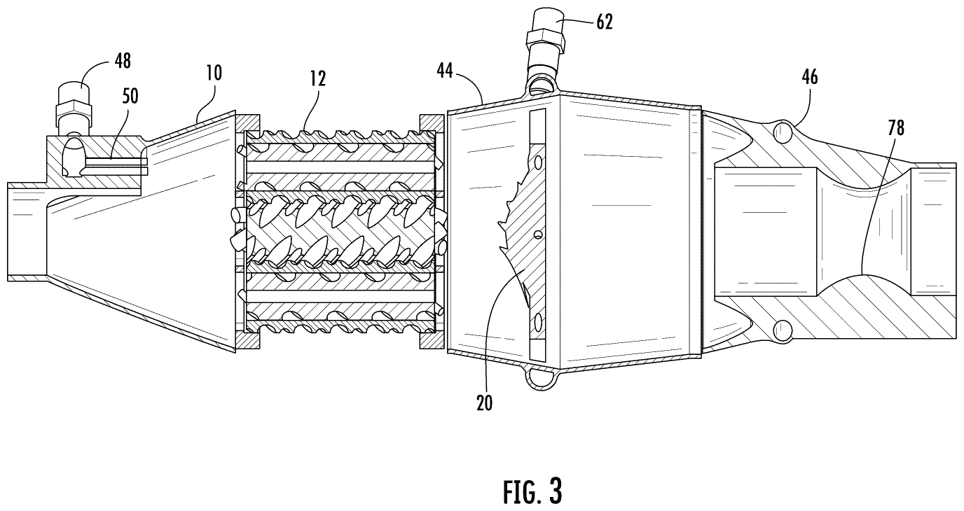

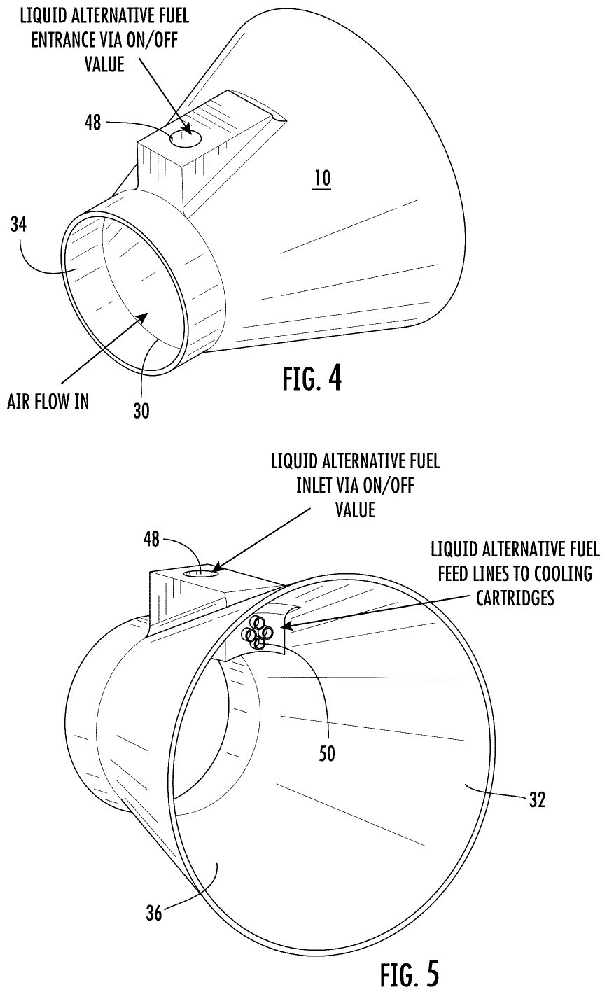

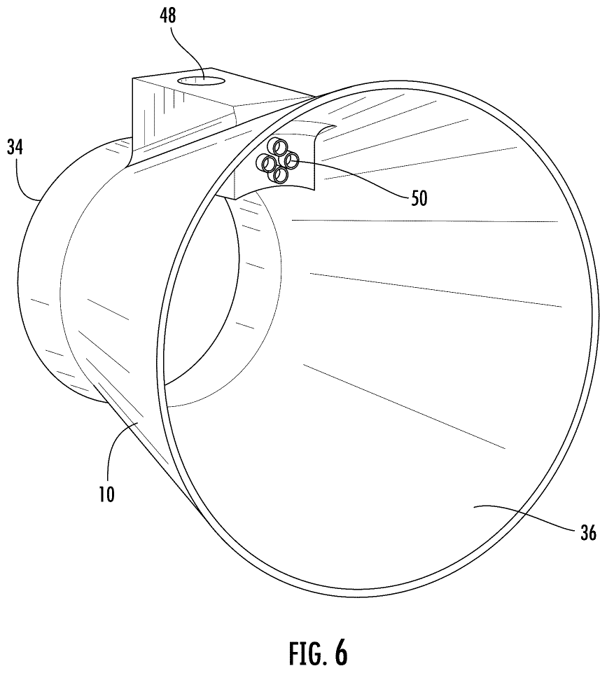

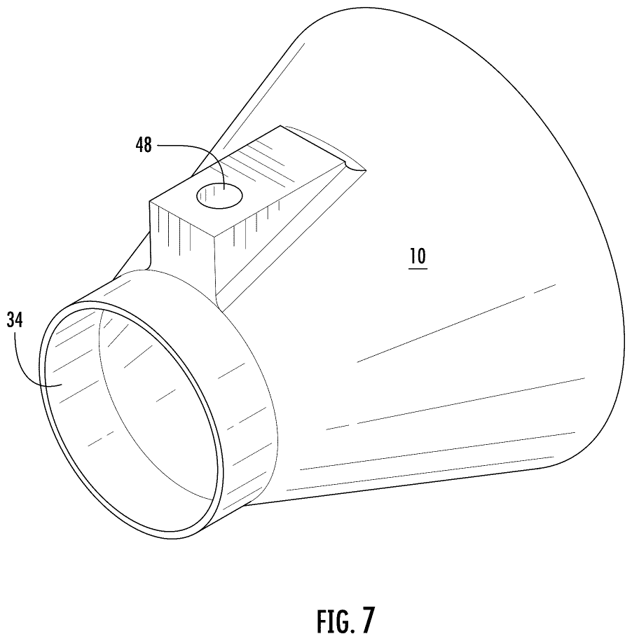

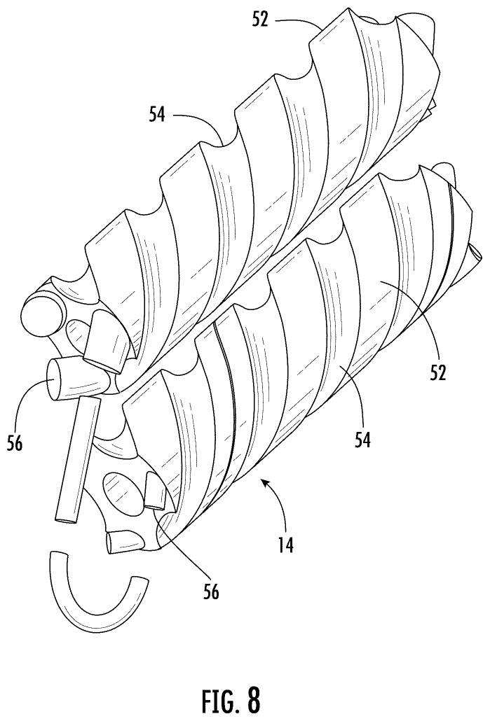

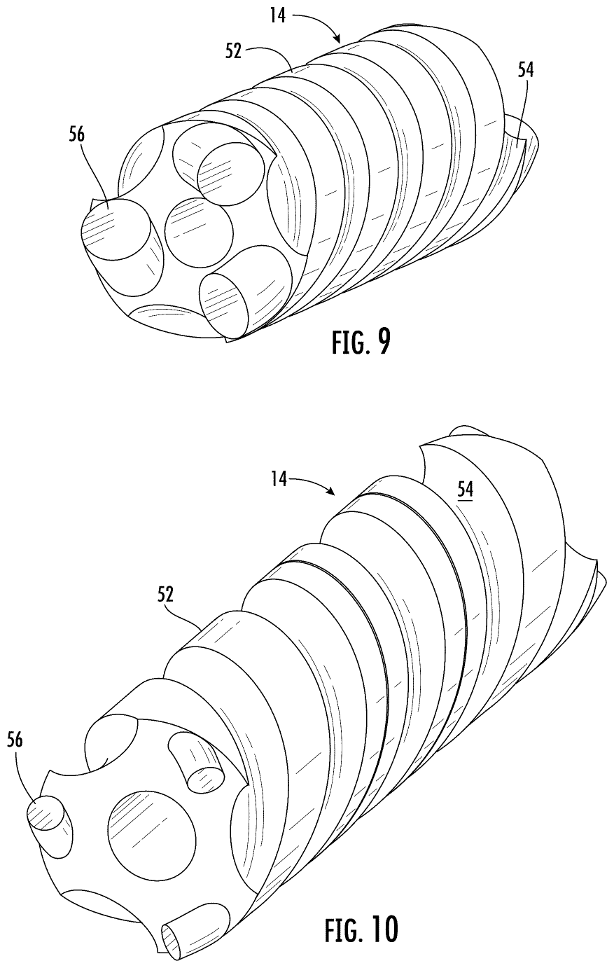

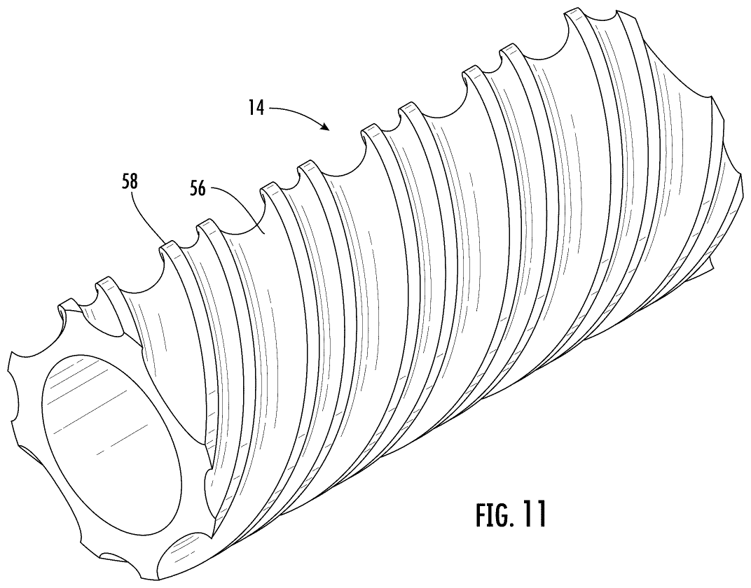

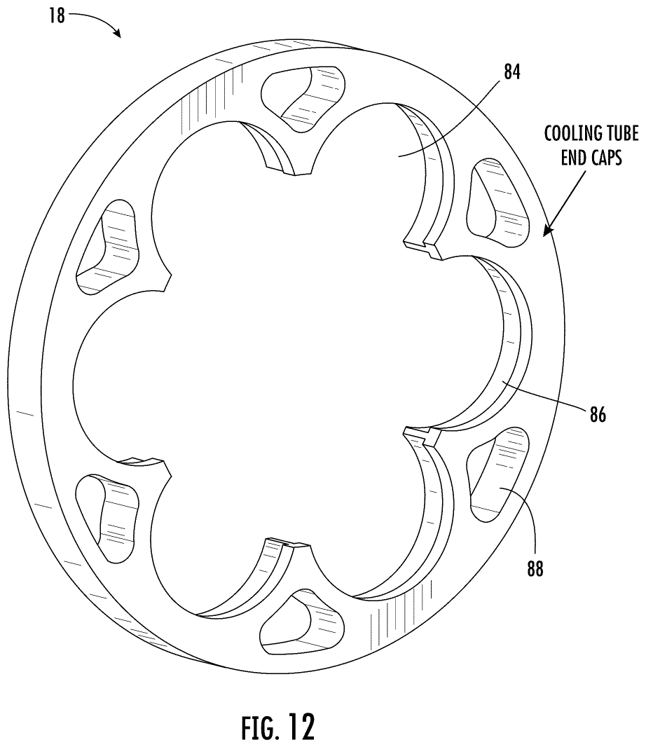

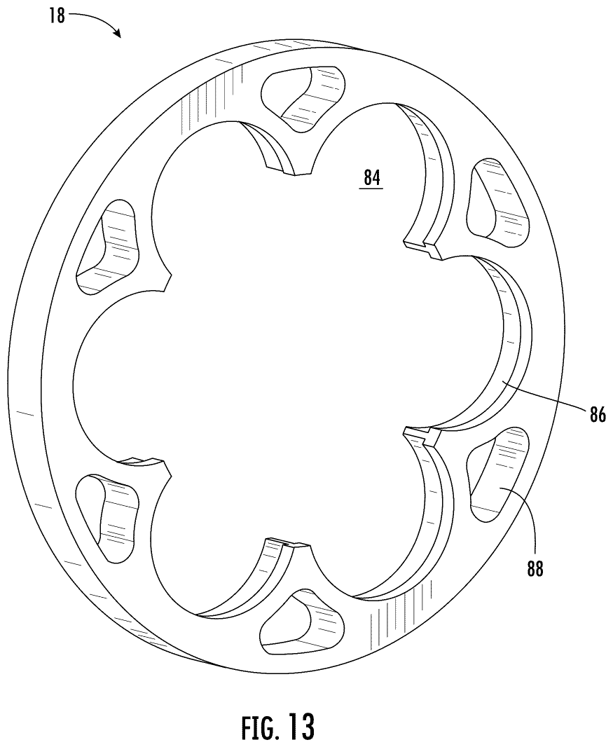

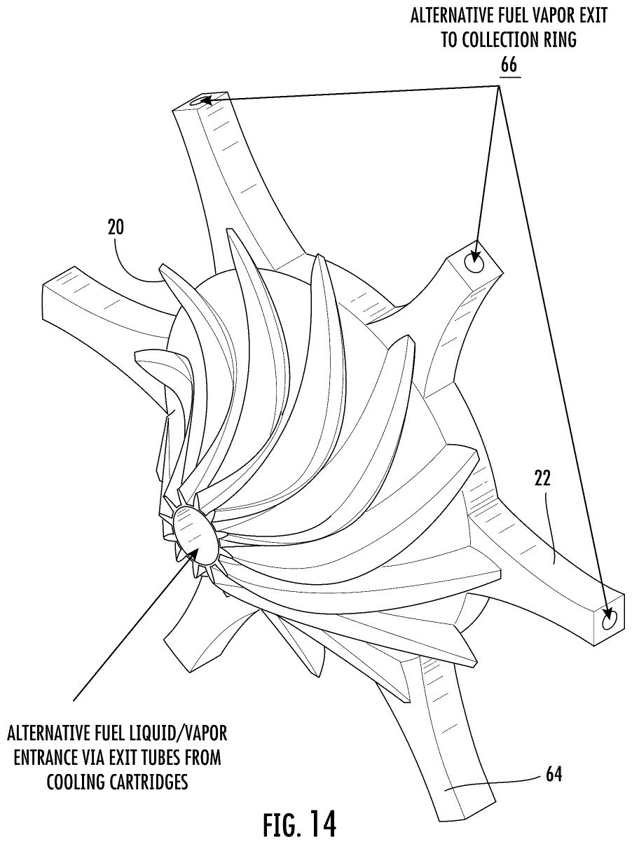

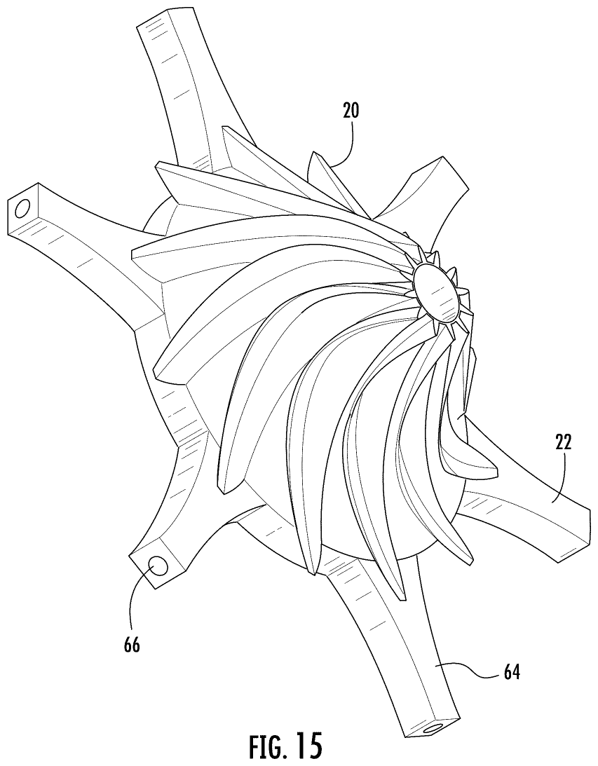

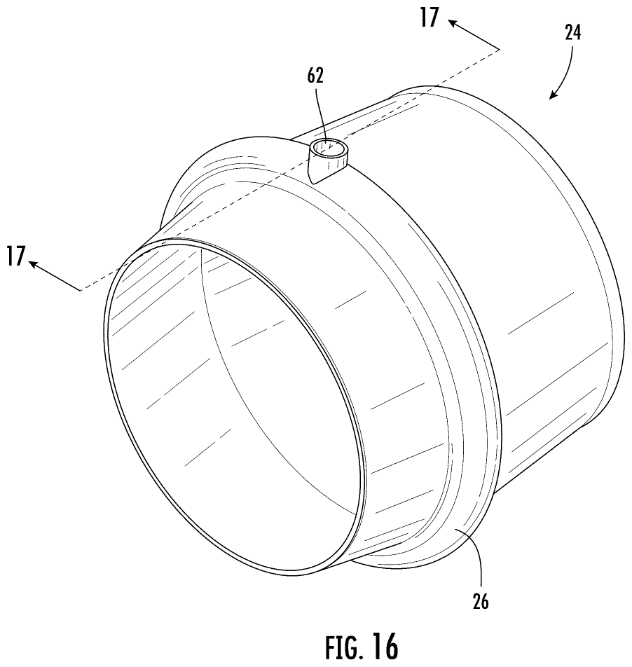

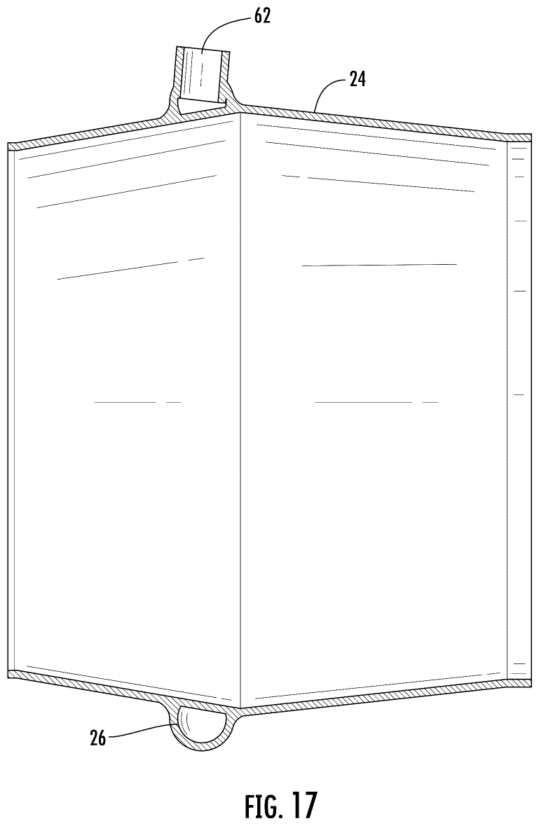

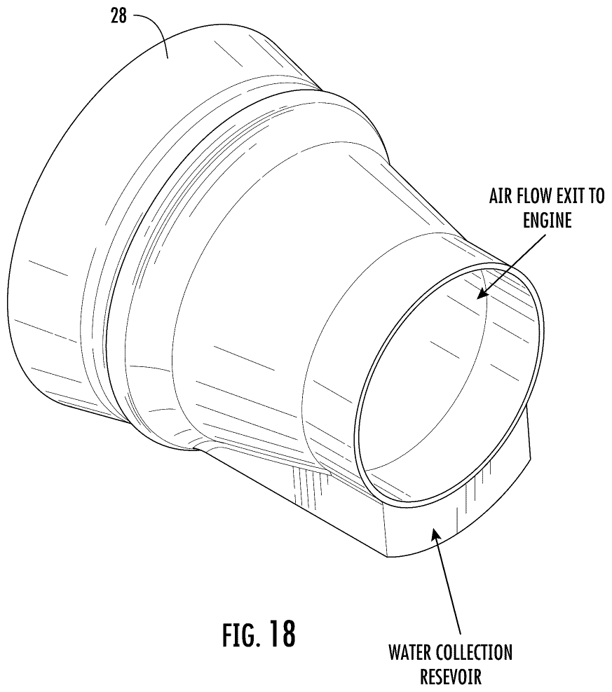

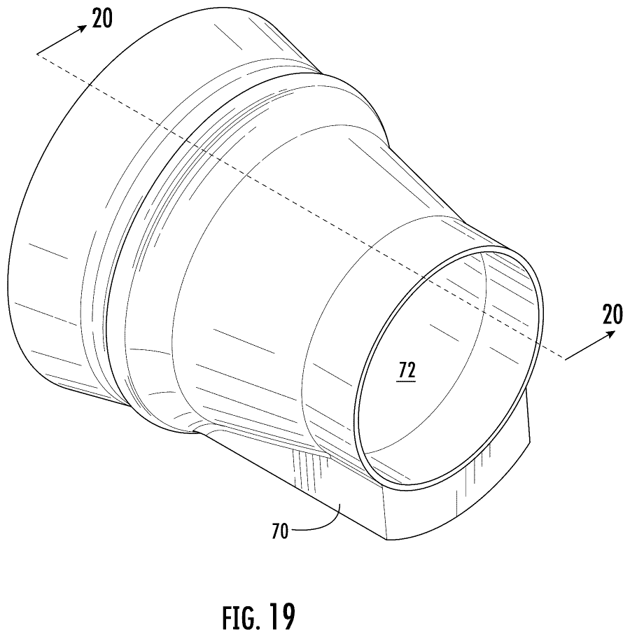

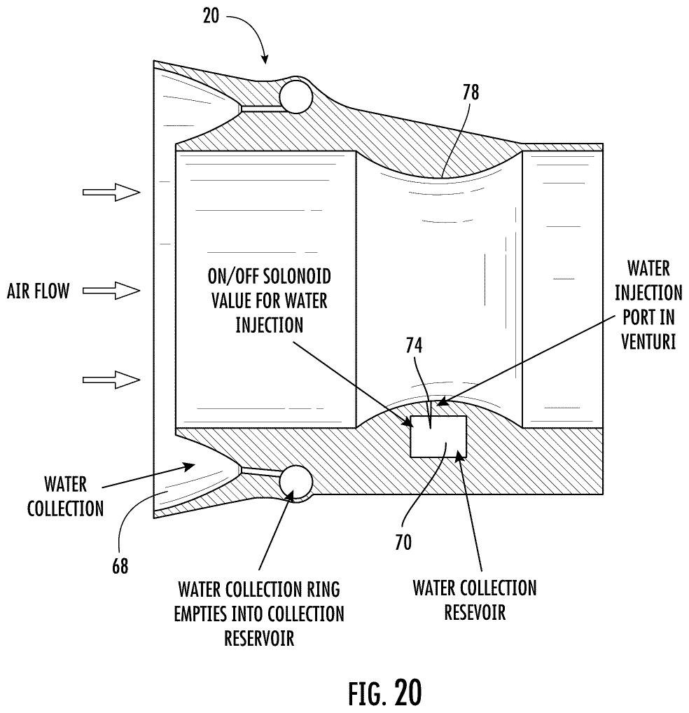

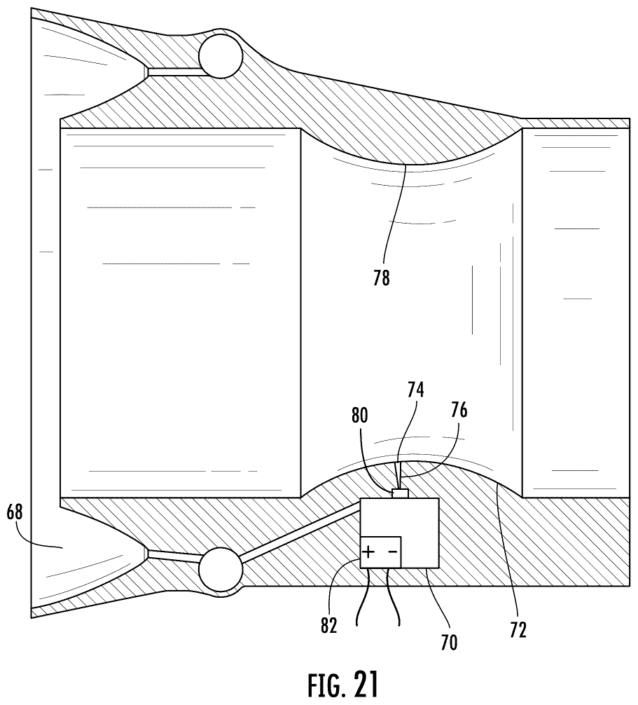

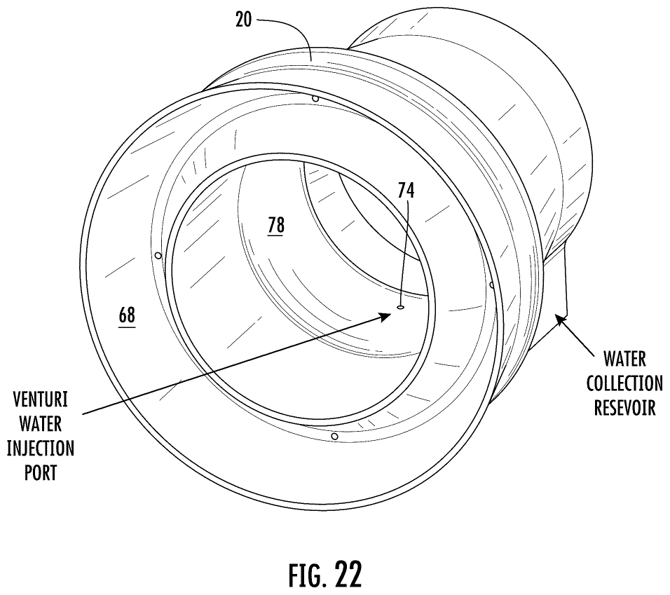

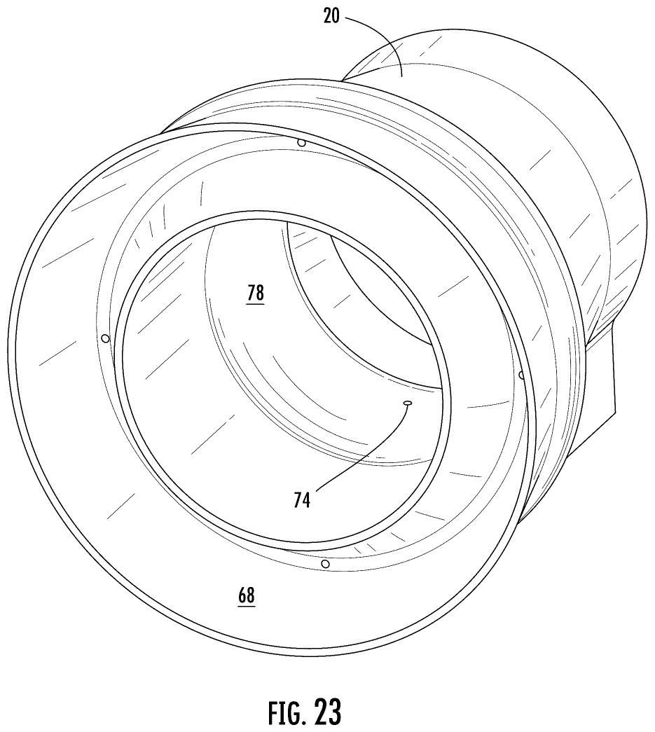

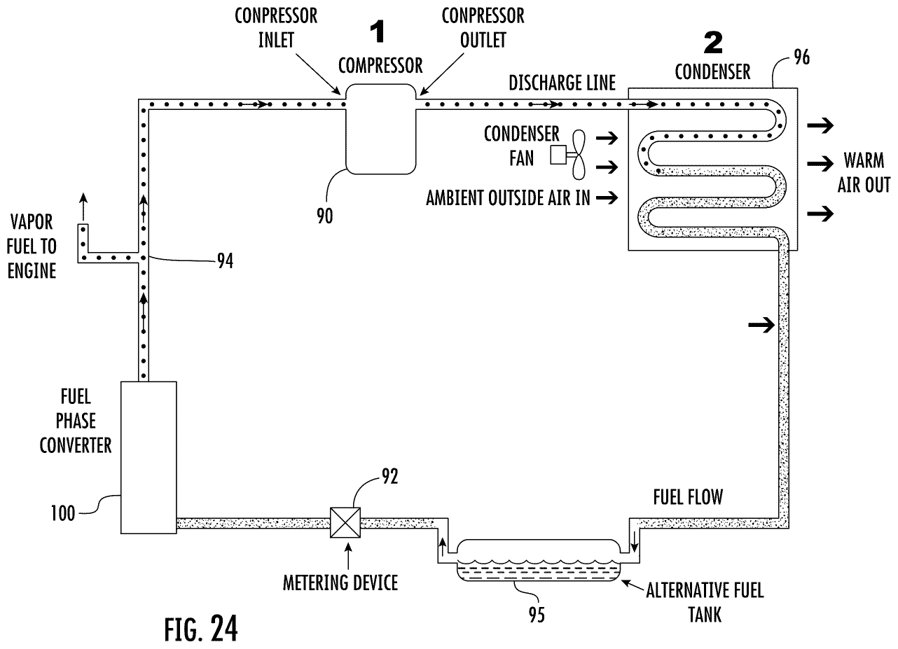

Referring generally to FIGS. 1-25, a fuel phase converter 100 for internal combustion engines is illustrated. The phase converter is constructed and arranged to convert a pressurized liquid fuel having a vapor pressure greater than atmospheric pressure at thirty-two degrees Fahrenheit or zero degrees Celsius to a vapor for introduction into the combustion chamber of an internal combustion engine.

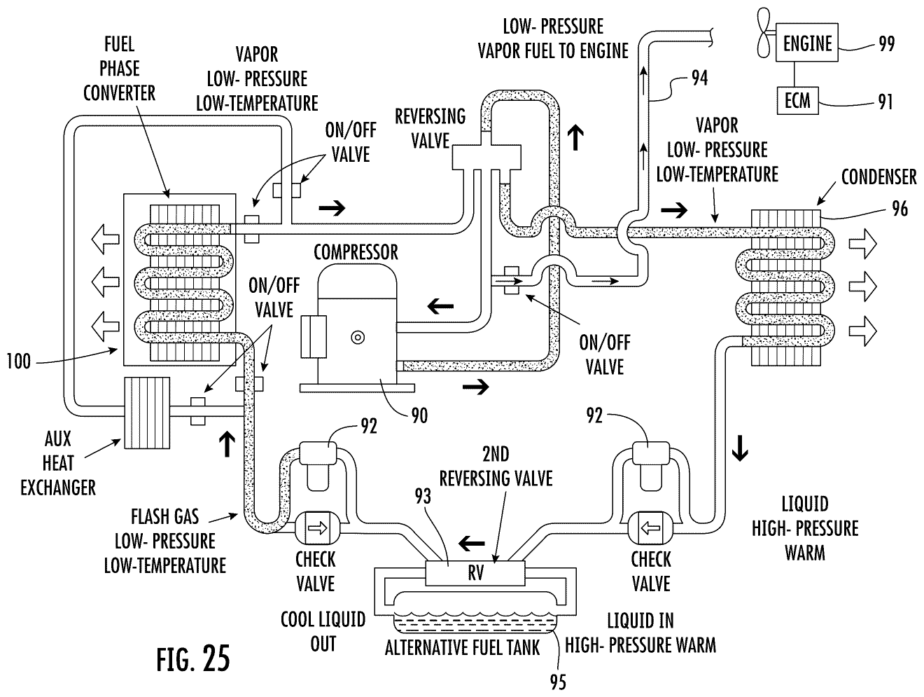

The fuel phase converter 100 converts a pressurized liquid fuel into a vapor fuel, wherein the vaporized fuel is introduced into a combustion chamber of the internal combustion engine for combustion. Suitable pressurized liquid fuels include, but should not be limited to, propane (LPG) (RLPG), dimethyl ether (DME) (RDME), liquified natural gas (LNG) (RLNG), compressed natural gas (CNG) (RCNG), butane, hydrogen, acetylene and methane, as well as suitable blends and combinations thereof. The fuel phase converter 100 utilizes the air being drawn under vacuum, or fed under pressure, into the intake of an engine for use in combustion for completing the phase change of the pressurized liquid fuel to gaseous fuel. In the process of vaporizing the liquid fuel, the incoming air is cooled or super cooled as it passes through the fuel phase converter before being passed to the cylinder for combustion. It should also be noted that compressed natural gas (CNG), while not a liquid unless stored at extremely high pressures, may be utilized with success in the present invention. In some embodiments, engine coolant or other heat may be needed to prevent regulator freeze up or pressure drop of the fuel due to regulator freezing. In the case of CNG, simply regulating the pressure from tank pressure to operating pressure can be utilized to cool the incoming air as it is passed through the present device. This is especially true when the CNG or other gas is passed through an expansion/metering valve when the gas is passed to the fuel phase converter. In some embodiments, a compressor 90 may be utilized to pressurize the gaseous or liquid fuel further before it is passed through a metering device 92 which may be an expansion valve or orifice. The compressor 90 may also be utilized to gather previously expanded fuel as a gas from the fuel phase converter 100 through suction line 94 and recompress the gaseous fuel, which may be a liquid or a gas after compression. The compressed fuel may be routed to a condenser 96 which may include a tank 95. The liquified or re-compressed fuel can thereafter be repassed through the metering valve 92 and released into the fuel phase converter 100. Thus, the expanded fuel may be consumed in combustion, or a portion of it may be recompressed multiple times before the fuel is consumed by the engine. The condenser 96 and/or tank 95 may be utilized to remove heat from the previously expanded fuel and to provide a higher degree of cooling to the fuel phase converter when the fuel is re-expanded. In this manner, the cooling may be routed to auxiliary systems, such as hydraulic or electrical systems, for cooling those systems. In these embodiments, an auxiliary heat exchanger 97 (FIG. 25) may be positioned in proximity to the auxiliary systems. In another embodiment, such as when CNG is being utilized as the alternative fuel, a coolant may be routed through the charge cooler and used to supply the heat to the regulator to prevent freeze up. In at least one embodiment, the compressor cycle can be reversed to impart heat to the charge air cooler, similarly to the operation of a heat pump. In this manner, the present system may be utilized in cold or harsh conditions to raise the temperature of the air entering the engine. Thus, in this embodiment, the compressed heated fuel is directed through the fuel phase converter 100 before being routed to the condenser 96 and back to the tank 95. This cycle can be completed with the addition of at least one reversing valve(s) 93. In the present application, the term “super cooling” means that the temperature of the air is such that the liquid water contained within the air is lowered below its freezing point without becoming a solid. The fuel phase converter includes a plurality of stages 40, 42, 44 and 46, respectively; the first stage 40 includes the air inlet cone 10 which is constructed and arranged to reduce the speed of the incoming air while routing the incoming air to a second stage 42 of the fuel phase converter 100. In one embodiment, the air inlet cone 10 includes an inlet opening 34 having a first area 30 and an outlet opening 36 having a second larger area 32. Thus, the incoming air enters the air inlet cone 10 at a higher speed than it exits the air inlet cone. In a most preferred embodiment, the air exits the air inlet cone at about half the speed in which it enters, with the ratio of the inlet area to the outlet area determining the exit speed of the air, with engine displacement and intake runner size determining the inlet air speed. The slower moving air provides added time in which the air stays in contact with the remaining stages of the fuel phase converter for removal of heat from the air. In the preferred embodiment, the air inlet cone 10 also introduces a fuel in a liquid phase to the fuel phase converter through a fuel inlet 48 via hose or line, etc. The liquid fuel is routed through at least one, and more preferably a plurality of liquid fuel feed lines 50, directing the liquid fuel to the second stage 42 of the fuel phase converter 100.

For receiving the pressurized liquid fuel, the second stage 42 includes at least one cooling cartridge assembly 12, each cooling cartridge assembly being constructed and arranged to simultaneously transfer heat from incoming air to the liquid fuel while the fuel absorbs the heat, causing a phase change of the liquid fuel to gas. The phase change of the fuel also cools the incoming air as the cooling cartridge assembly is cooled due to the phase change of the fuel. The second stage 42 of the fuel phase converter is provided with at least one, and more preferably a plurality of the cooling cartridge assemblies. The number of cooling cartridge assemblies 12 generally increases as the size of the engine that is receiving the fuel increases. The cooling cartridge assemblies 12 may be connected in series or in parallel without departing from the scope of the invention. In a preferred embodiment, each cooling cartridge assembly 12 includes a cooling cartridge sleeve 14, a cooling cartridge core 16, and a pair of cooling cartridge end caps 18. The cooling cartridge core 16 is positioned inside of the cooling cartridge sleeve 14, the cooling cartridge end caps 18 maintaining the positioning of the cooling cartridge sleeve 14 and cooling cartridge core 16 in an airtight arrangement so that the liquid fuel and gaseous fuel are maintained within the cooling cartridge assembly 12 and separated from the incoming air. In this manner, the incoming air can be in direct contact with the outer surface 52 of the cooling cartridge assembly. Preferably, the outer surface 52 includes at least one helical groove 54 which allows the incoming air to be in closer contact with the phase changing fuel. By removing a portion of the cooling cartridge sleeve 14, the air is closer to the helical conduit 56 that extends along an outer surface 58 of the cooling cartridge core 16, and thus closer to the phase change of the fuel. In at least one embodiment, the cooling cartridge core 16 is sized to fit within an inner bore 60 of the cooling cartridge sleeve 14 to create the helical conduit 56. Cooling cartridge end caps 18 hold the core 16 and sleeve 14 in position with respect to each other, while the end caps 18 seal the assembly for the fuel flow. The end caps 18 include an inner bore shape 84. The inner bore shape 84 includes a stepped inner surface 86; the steps constructed and arranged to position the cooling cartridge sleeve 14 and cooling cartridge core 16 in position with respect to each other. Air flow holes 88 are also provided in the cooling cartridge end caps 18 for allowing the free flow of air through the cooling cartridge end caps 18. In at least one embodiment, the air flow holes 88 are cut or drilled at about the same angle as the cooling cartridge helical cuts to provide swirl to the air flowing through the cooling cartridge. The fuel, after being vaporized, is transferred to a third stage of the cooling cartridge assembly. The third stage 44 includes a centrifugal inertia swirler 20 for imparting a rotation to the incoming air. The third stage 44 also includes a collection ring 22 for collecting the gasified fuel for routing outside of the fuel phase converter 100 and to the engine for combustion through a gas orifice 62. A fuel collection shroud 24 is provided to surround the third stage 44. The fuel collection shroud 24 includes a fuel collection conduit 26 arranged to extend around the third stage for receiving the gasified fuel from the collection ring 22. The collection ring 22 is constructed to include spokes 64 which radiate divergently outward until they meet the collection conduit 26. The spokes 64 may include angles cut on the outer surfaces of the spokes to further assist in generating a swirl in the air flowing through the fuel phase converter 100. It should be noted that the angled surfaces and the swirl of the air assist in directing the condensation of water to the inner wall for collection. In this manner, the incoming air can pass through and around the collection ring 22 as a rotating mass. The gasified fuel is collected in the fuel collection conduit 26 for passage to the gas orifice 62 and on to the engine for combustion. The centrifugal inertia swirler 20 imparts sufficient rotation to the incoming air to cause water droplets within the incoming air to be centrifugally spun out of the incoming air as the air is moved to a fourth stage 46 of the fuel phase converter 100. The fourth stage 46 includes a water collection channel 68 included as a portion of the water collection shroud 28 which surrounds the fourth stage. In operation, the water is moved to the outside of the spinning incoming air and drier air is positioned at a center portion of the incoming air, the water collecting from the inner wall surface and directed to the water collection channel 68. The collected water in the water collection channel 68 is routed to a water collection tank 70 for storing the collected water. In at least some embodiments, the collected water is selectively reintroduced into the stream of incoming air for mixture with the dried air and combustion. In one embodiment, the fourth stage 46 of the fuel phase converter 100 includes a venturi 72; the venturi 72 including at least one venturi aperture 74, the at least one venturi aperture 74 aligned with a water conduit 76 extending between the water tank 70 and the low pressure point 78 of the venturi 72, wherein incoming air passing through the venturi 72 draws the water into the incoming air stream. In some embodiments, a solenoid valve 80 is included between the venturi aperture 74 and the water tank 70 for controlling the flow of the water through the venturi aperture 74. In this manner, introduction of the water can be selective or computer controlled to deliver an increased air density to the engine as needed for horsepower or emissions requirements. In at least embodiment, an electrolysis system 82 is included within the water tank 70 and powered by the batteries of the vehicle to cause the generation of hydrogen and oxygen from breaking down the water to its component parts. The hydrogen and oxygen are then drawn into the incoming air as it passes the venturi aperture 74 of the venturi 72. In some embodiments, this can be controlled by the ECM 91, and thus be introduced to the engine 99 as needed based upon engine parameters monitored by the ECM which may include artificial intelligence (AI). An internal combustion engine that utilizes parameters such as diesel fuel consumption, engine load, engine RPM, engine temperature, exhaust temperature, air intake temperature, ambient temperature, emissions sensors to make artificial intelligence decisions regarding how much alternative fuel to supply to the engine for combustion and in some embodiments the addition and dual fuel operation of a diesel engine.

It is known that the injection of water or water vapor into the incoming air stream of an engine will further cool the combustion process and introduce more oxygen to process, which should reduce NOX and CO2 emissions and increase engine efficiency. It should also be noted that in some embodiments the fuel phase change may occur partially or fully within a heated regulator when the fuel phase converter 100 is below a predetermined temperature. The fuel phase converter 100 should provide sufficient heat to the liquid fuel to cause the phase change. When this temperature is too low, the fuel can be converted to vapor or gas outside of the fuel phase converter and mixed with the incoming air as it is cooled passing through the fuel phase converter, thus maintaining the cooling of the incoming air stream. When the temperature of the fuel phase converter raises above the predetermined temperature, the phase change is then restored to the fuel phase converter. In the preferred embodiment, the fuel phase converter 100 is constructed from aluminum for its conductive properties and ease of machining. However, the fuel phase converter may be constructed from any suitable material that provides conductivity suitable to phase change a sufficient amount of liquefied gaseous fuel from liquid to gas. It should also be noted that some embodiments may include an outer shroud (not shown) which may be insulated to insure that heat provided to the fuel phase convertor 100 is primarily provided by the incoming air stream.

Thus, as has been shown and described, the present system may be utilized as a stand-alone fuel system or as part of a dual fuel system, as shown and described in the Applicant's prior art, e. g. U.S. Pat. Nos. 10,890,106, 11,236,665, 11,486,295, and 12,018,610, the contents of which are incorporated herein by reference.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention, and that the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A fuel phase converter for an internal combustion engine comprising:
the fuel phase converter (100) including a plurality of stages, a first stage (40) includes an air inlet cone (10) which is constructed and arranged to reduce the speed of incoming air while routing the incoming air to a second stage (42),
the second stage (42) of the fuel phase converter (100) is provided with at least one cooling cartridge assembly (12), the cooling cartridge assembly (12) is constructed and arranged so that a liquid fuel is expanded by passage through a metering orifice (92), converting the liquid into a gaseous phase for passage through cooling the cartridge assembly (12) and separated from the incoming air by a heat transferring portion of the fuel phase converter, the incoming air in direct contact with an outer surface of the cooling cartridge assembly (12), the second stage (42) routing the incoming air to a third stage (44),
the third stage (44) includes a centrifugal inertia swirler (20) for imparting a rotation to the incoming air; the third stage (44) also includes a collection ring (22) for collecting the gasified fuel for routing outside of the fuel phase converter (100) and to the engine for combustion through a gas orifice (62), wherein the incoming air is cooled and the gasified fuel is combusted in the engine.

2. The fuel phase converter (100) for an internal combustion engine of claim 1 including a fourth stage (46), the fourth stage (46) includes a water collection channel (68) as a portion of a water collection shroud (28) which surrounds the fourth stage (46), wherein water in the incoming air is moved to the outside of the spinning air, collecting on the inner wall surface and directed to the water collection channel (68).

3. The fuel phase converter (100) for an internal combustion engine of claim 2 wherein the collected water in the water collection channel (68) is routed to a water collection tank (70) for storing the collected water.

4. The fuel phase converter (100) for an internal combustion engine of claim 3 wherein the collected water is selectively reintroduced into the stream of incoming air for combustion.

5. The fuel phase converter (100) for an internal combustion engine of claim 3 wherein the fourth stage (46) of the fuel phase converter (100) includes a venturi (72), the venturi (72) including at least one venturi aperture (74), the at least one venturi aperture (74) aligned with a water conduit (76) extending between the water collection tank (70) and a low pressure point (78) of the venturi (72), wherein incoming air passing through the venturi (72) draws the water into the incoming air stream.

6. The fuel phase converter (100) for an internal combustion engine of claim 5 including a solenoid valve (80) for controlling the flow of water through the venturi aperture (74).

7. The fuel phase converter (100) for an internal combustion engine of claim 6 wherein the solenoid valve (80) is positioned between the venturi aperture (74) and the water tank (70) for controlling the flow of the water through the venturi aperture (74).

8. The fuel phase converter (100) for an internal combustion engine of claim 1 wherein a fuel collection shroud (24) is provided to surround the third stage (44), the fuel collection shroud (24) includes a fuel collection conduit (26) arranged to extend around the third stage (44) for receiving the gasified fuel from the collection ring (22), the collection ring (22) constructed to include spokes (64) which radiate divergently outward until they meet the collection conduit (26).

9. The fuel phase converter (100) for an internal combustion engine of claim 8 wherein the spokes (64) include angles cut on the outer surfaces of the spokes (64) to further assist in generating a swirl along the longitudinal axis of the air flowing through the fuel phase converter (100).

10. The fuel phase converter (100) for an internal combustion engine of claim 1 wherein the air inlet cone (10) includes an inlet opening (34) having a first area (30) and an outlet opening (36) having a second larger area (32) so that the incoming air enters the air inlet cone (10) at a higher speed than the air exits the air inlet cone (10).

11. The fuel phase converter (100) for an internal combustion engine of claim 1 wherein a compressor (90) is utilized to gather previously expanded fuel as a gas from the fuel phase converter (100) through suction line (94) and recompress the gaseous fuel into a liquid before routing the liquid to a tank (95).

12. The fuel phase converter (100) for an internal combustion engine of claim 11 wherein the compressed fuel is directed through a condenser (96) before being directed to the tank (95).

13. The fuel phase converter (100) for an internal combustion engine of claim 11 wherein the compressor cycle is reversed to provide heat to the fuel phase converter (100) and thus the incoming air.

14. The fuel phase converter (100) for an internal combustion engine of claim 11 wherein the expanded fuel may be recompressed multiple times and passed through the fuel phase converter (100) before the fuel is consumed by the engine.

15. The fuel phase converter (100) for an internal combustion engine of claim 11 including an electronic control module 91 that utilizes artificial intelligence to monitor the supply of a gaseous fuel and liquid fuel supplied to an internal combustion engine that utilizes multiple sensor readings from the engine to make artificial intelligence decisions regarding how much alternative fuel to supply to the engine for combustion and how much diesel fuel to supply to the engine for combustion.
